(19) United States
(12) Patent Application Publication
(10) Pub. No.: US 2023/0367124 A1
(43) Pub. Date: Nov. 16, 2023

(54) LIGHTGUIDE ASSEMBLY WITH SWITCHABLE INPUTS

(71) Applicant: Meta Platforms Technologies, LLC, Menlo Park, CA (US)

(72) Inventors: Sihui He, Sunnyvale, CA (US); Xiayu Feng, Kirkland, WA (US); Renate Eva Klementine Landig, Kirkland, WA (US); Jacques Gollier, Sammamish, WA (US)

(21) Appl. No.: 18/124,424

(22) Filed: Mar. 21, 2023

Related U.S. Application Data
(60) Provisional application No. 63/341,416, filed on May 12, 2022.
(60) Provisional application No. 63/395,295, filed on Aug. 4, 2022.

(51) Int. Cl. G02B 27/01

(52) U.S. Cl. CPC G02B 27/0172

(57) ABSTRACT

A lightguide assembly includes a stack of optically separated lightguide plates for conveying image light to an eyebox. At least one lightguide plate of the stack includes an in-coupler configured for switchably in-coupling the image light into the lightguide plate. The switchable in-coupler(s) may be used to time-sequence through different lightguides of the stack, each lightguide carrying a portion of the image such as a field of view portion or a color channel of the image. The time-sequencing through the lightguides allows one to compensate for image offsets due to the lightguide being non-parallel to one another, by providing corresponding offsets in the image portions being carried by different lightguides.

### REFERENCE TO RELATED APPLICATIONS

This application claims priority from U.S. Provisional Patent Application No. 63/341,416 entitled “Active Eyebox Solutions and Applications” filed on May 12, 2022, and U.S. Provisional Patent Application No. 63/395,295 entitled “Lightguide Assembly with Switchable Inputs” filed on Aug. 4, 2022, both of which being incorporated herein by reference in their entireties.

### TECHNICAL FIELD

The present disclosure relates to visual display devices and related components, modules, and methods.

### BACKGROUND

Visual displays provide information to viewer(s) including still images, video, data, etc. Visual displays have applications in diverse fields including entertainment, education, engineering, science, professional training, advertising, to name just a few examples. Some visual displays, such as TV sets, display images to several users at a time, and some visual display systems, such s near-eye displays (NEDs), are intended for individual users.

An artificial reality system generally includes an NED (e.g., a headset or a pair of glasses) configured to present content to a user. The near-eye display may display virtual objects or combine images of real objects with virtual objects, as in virtual reality (VR), augmented reality (AR), or mixed reality (MR) applications. For example, in an AR system, a user may view images of virtual objects (e.g., computer-generated images) superimposed with the surrounding environment by seeing through a “combiner” component. The combiner of a wearable display is typically transparent to external light but includes light routing optics to direct the display light into the user's field of view.

Because a display of HMD or NED is usually worn on the head of a user, a large, bulky, unbalanced, and/or heavy display device with heavy electro-optical modules and heavy battery would be cumbersome and uncomfortable for the user to wear. Consequently, head-mounted display devices can benefit from a compact and efficient configuration. A compact configuration may be achieved by using such optical elements as Fresnel lenses, diffractive optical elements, lightguides, and the like. Compact optical elements, although being convenient to use, may suffer from a variety of deficiencies including ghosting, image distortion or splitting, rainbow effects, etc.

### BRIEF DESCRIPTION OF THE DRAWINGS

Exemplary embodiments will now be described in conjunction with the drawings, in which:

FIG. 1 is a side cross-sectional view of a display device including a lightguide assembly of this disclosure;

FIG. 2 is a side cross-sectional view of an embodiment of the lightguide assembly of this disclosure with polarization-selective in-couplers;

FIG. 3 is a side cross-sectional view of an embodiment of the lightguide assembly of FIG. 1 with switchable in-couplers;

FIG. 4 is a schematic view of an embodiment of the display device of FIG. 1 with an optional disparity sensor;

FIG. 5 is a flow chart of a method for lessening an offset between portions of an image using a lightguide assembly of this disclosure;

FIG. 6 shows side cross-sectional views of a tunable liquid crystal (LC) surface-relief grating usable in lightguides of this disclosure;

FIG. 7A is a frontal view of an active Pancharatnam-Berry phase (PBP) liquid crystal (LC) grating usable in lightguides of this disclosure;

FIG. 7B is a magnified schematic view of LC molecules in an LC layer of the active PBP LC grating of FIG. 7A;

FIGS. 8A and 8B are side schematic views of the active PBP LC grating of FIGS. 7A and 7B, showing light propagation in OFF (FIG. 7A) and ON (FIG. 7B) states of the active PBP LC grating;

FIG. 9A is a side cross-sectional view of a polarization volume grating (PVH) usable in lightguides of this disclosure;

FIG. 9B is a diagram illustrating optical performance of the PVH of FIG. 9A;

FIG. 10A is a side cross-sectional view of a fluidic grating usable in lightguides of this disclosure, in an OFF state;

FIG. 10B is a side cross-sectional view of the fluidic grating of FIG. 10A in an ON state;

FIG. 11A is a side cross-sectional view of a lightguide of this disclosure including an acoustic actuator for creating a volume acoustic wave in the lightguide;

FIG. 11B is a side cross-sectional view of a lightguide of this disclosure including an acoustic actuator for creating a surface acoustic wave in the lightguide;

FIG. 12 is a side cross-sectional view of a lightguide of this disclosure with a low-index layer between a voltage-controlled layer and an array of electrodes;

FIG. 13 is a view of an augmented reality (AR) display of this disclosure having a form factor of a pair of eyeglasses; and

FIG. 14 is a three-dimensional view of a head-mounted display (HMD) of this disclosure.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art. All statements herein reciting principles, aspects, and embodiments of this disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

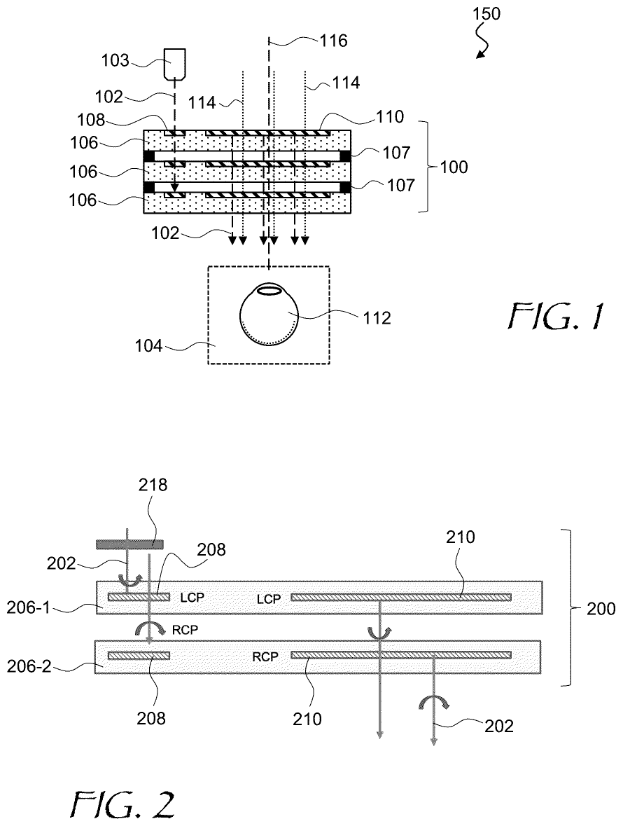

As used herein, the terms “first”, “second”, and so forth are not intended to imply sequential ordering, but rather are intended to distinguish one element from another, unless explicitly stated. Similarly, sequential ordering of method steps does not imply a sequential order of their execution, unless explicitly stated. In FIGS. 1-3, similar reference numerals denote similar elements.

A lightguide assembly for a near-eye display may include a stack of lightguide plates each conveying a portion of the overall field of view (FOV) and/or different color channel(s), or different subsets of color channels, of a generated image. Typically, lightguide plates need to be precisely aligned to one another to avoid splitting of the displayed image, which may be a difficult and time-consuming operation. In accordance with this disclosure, the in-coupling of image light into individual lightguide plates may be switched to cause the lightguides to operate in a time-sequential manner. This enables a residual misalignment between different lightguide plates to be compensated in software/firmware, by pre-shifting partial images to be carried by individual lightguide plates.

In accordance with the present disclosure, there is provided a lightguide assembly for propagating image light to an eyebox. The lightguide assembly comprises a stack of optically separated lightguide plates for conveying the image light/At least one lightguide plate of the stack comprises an in-coupler configured for switchably in-coupling the image light into the lightguide plate, and an out-coupler for out-coupling spaced apart portions of the image light from the lightguide plate towards the eyebox.

In some embodiments, the stack comprises first and second lightguide plates each comprising an in-coupler configured for switchably in-coupling the image light into the lightguide plate, and an out-coupler for out-coupling spaced apart portions of the image light from the lightguide plate towards the eyebox. The in-coupler of the first lightguide plate may include a first polarization-selective grating for in-coupling light in a first polarization state while propagating therethrough light in a second, orthogonal polarization state. The in-coupler of the second lightguide plate may include a second polarization-selective grating for in-coupling light in the second polarization state while propagating therethrough light in the first polarization state. The lightguide assembly may further include a polarization switch upstream of the first and second polarization-selective gratings for switching a polarization state of the image light between the first and second polarization states.

In some embodiments, the in-coupler comprises a switchable grating for switchably in-coupling the image light into a corresponding lightguide plate of the stack. The switchable grating may include e.g. a tunable liquid crystal surface-relief grating, a Pancharatnam-Berry phase (PBP) LC switchable grating, a polarization volume hologram (PVH) grating, a fluidic grating, and/or an acoustic grating.

In accordance with the present disclosure, there is provided a display device comprising a projector for providing image light carrying an image in angular domain, a lightguide assembly optically coupled to the projector for receiving and propagating the image light to an eyebox, and a controller operably coupled to the projector and the lightguide assembly. The lightguide assembly comprises a stack of optically separated lightguide plates for conveying the image light therein. At least one lightguide plate of the stack comprises an in-coupler configured for switchably in-coupling the image light into the lightguide plate, and an out-coupler for out-coupling the image light from the lightguide plate towards the eyebox.

In some embodiments, the in-coupler comprises a switchable grating for switchably in-coupling, responsive to a control signal from the controller, the image light into a corresponding lightguide plate of the stack. In embodiments where the stack comprises first and second lightguide plates, the controller may be configured to do the following. During a first time interval, the controller causes the projector to provide a first portion of the image light carrying a first portion of the image in angular domain. During the first time interval, the controller also causes the lightguide assembly to in-couple the image light into the first lightguide plate and to convey the image light in the first lightguide plate towards the eyebox. During a second, subsequent time interval, the controller causes the projector to provide a second portion of the image light carrying a second portion of the image in angular domain. During the second time interval, the controller causes the lightguide assembly to in-couple the image light into the second lightguide plate and to convey the image light in the second lightguide plate towards the eyebox. The first and second portions of the image in angular domain may be e.g. first and second portions of field of view (FOV), respectively, of the image in angular domain, and/or first and second color channels, respectively, of the image in angular domain.

In embodiments where the first lightguide plate comprises a first polarization-selective grating for in-coupling light in a first polarization state while propagating therethrough light in a second, orthogonal polarization state, and the second lightguide plate comprises a second grating for in-coupling light in the second polarization state, the lightguide assembly may further include a polarization switch upstream of the first and second lightguide plates for switching, responsive to a control signal from the controller, a polarization state of the image light between the first and second polarization states.

In some embodiments, the display device further comprises a disparity sensor operably coupled to the controller, for sensing an offset between the first and second portions of the image in angular domain at the eyebox. In such embodiments, the controller may be configured to cause the projector to offset the first and second portions of the image in angular domain to lessen an offset between the first and second portions of the image in angular domain at the eyebox due to misalignment between the first and second lightguide plates.

In accordance with the present disclosure, there is further provided a method for lessening an offset between first and second portions of an image in angular domain due to misalignment between first and second lightguide plates carrying the first and second portions of the image in angular domain respectively. The method comprises providing the first and second portions of the image in angular domain in a time-sequential manner, and providing an offset between the first and second portions of the image in angular domain to compensate for the misalignment between first and second lightguide plates.

In some embodiments, the first portion of the image is provided during a first time interval and the second portion of the image is provided during a second, subsequent time interval, the first and second portions of the image comprising a common feature. For such embodiments, the method further comprises determining a position of the common feature during the first time interval, determining a position of the common feature during the second time interval, and comparing the determined common feature positions to determine the offset. The first and second portions of the image in angular domain may include e.g. first and second portions of field of view (FOV), respectively, of the image in angular domain, and/or first and second color channels, respectively, of the image in angular domain.

Referring now to FIG. 1, a lightguide assembly 100 for propagating image light 102 generated by an image projector 103 to an eyebox 104 includes a stack of separated lightguide plates 106 for conveying the image light 102. The image light 102 carries an image in angular domain, i.e. an image where individual pixels are represented by corresponding ray angles, in contradistinction e.g. to an image in linear domain where individual pixels (i.e. elements of the image being displayed) are represented by corresponding ray coordinates.

The lightguide plates 106 of the lightguide assembly 100 are separated optically, preventing leakage of the image light due to evanescent or refractive coupling between individual lightguide plates 106. For example, the lightguide plates 106 may be separated by a set of spacers 107, e.g. glass beads, honeycomb structures, and/or a low refractive index material, by a distance of at least 2-3 micrometers. Each lightguide plate 106 includes an in-coupler 108 configured for in-coupling the image light 102 into the lightguide plate, and an out-coupler 110 configured for out-coupling the image light from the lightguide plate 106 towards the eyebox 104 for observation of an image carried by the image light by a user's eye 112. As the image light 102 propagates in the lightguide plates 106, spaced apart portions of the image light 102 may be out-coupled from the lightguide plates 106 to fill the eyebox 104. At least one of the in-couplers 108 may be switchable ON and OFF. In the ON state, the in-coupler 108 in-couples the image light 102 into the respective lightguide, and in the OFF state, the image light 102 propagates to a next lightguide 106/next in-coupler 108.

The lightguide assembly 100 and the image projector 103 are optical modules of a near-eye display (NED) 150. For augmented reality (AR) embodiments of the NED 150, the lightguide plates 106 may be made at least partially transparent for external light 114 co-propagating with the image light 102 along a common light path 116. The lightguide stack may include two, three, four, or more individual lightguide plates, as required.

Referring to FIG. 2 with further reference to FIG. 1, a lightguide assembly 200 is an embodiment of the lightguide assembly 100 of FIG. 1, and includes similar elements. The lightguide assembly 200 of FIG. 2 has two lightguide plates, a first (upstream) lightguide plate 206-1, and a second (downstream) lightguide plate 206-2, each having an in-coupler 208 and an out-coupler 210. The in-coupler 208 of the first lightguide plate 206-1 may include a first polarization-selective grating for in-coupling light in a first polarization state while propagating therethrough light in a second, orthogonal polarization state. The in-coupler of the second lightguide plate 206-2 may include a second polarization-selective grating for in-coupling light in the second polarization state while propagating therethrough light in the first polarization state, or a regular, i.e. not switchable, in-coupling grating. The lightguide assembly 200 further includes a polarization switch 218, e.g. a switchable half-wave plate, upstream of the first and second polarization-selective gratings, for switching a polarization state of image light 202 between the first and second polarization states in response to a control signal from a controller. Depending on the polarization state of the image light 202 controlled by the polarization switch 218, either the first 206-1 or the second 206-2 in-coupler in-couples the image light 202 into a respective lightguide 206-1 or 206-2.

The first 206-1 and second 206-2 lightguide plates may convey portions of the image light 202 carrying different, albeit possibly overlapping, portions of the image in angular domain, i.e. different FOV portions. In the illustrated example, the first and second orthogonal polarization states are left circular polarization (LCP) and right circular polarization (RCP), respectively. The LCP/RCP polarization-selective gratings may include polarization volume hologram (PVH) gratings, which are described in detail further below.

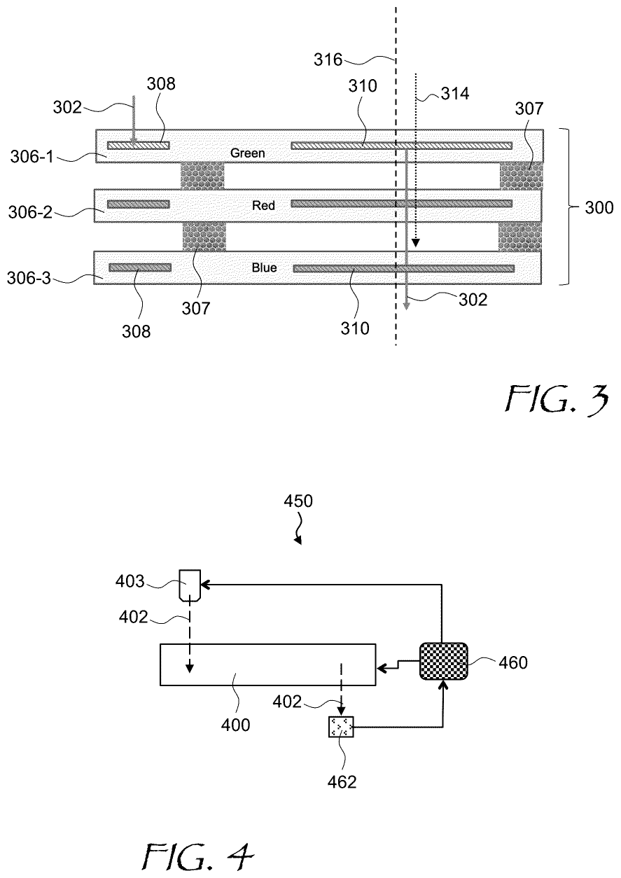

Turning to FIG. 3 with further reference to FIG. 1, a lightguide assembly 300 is an embodiment of the lightguide assembly 100 of FIG. 1, and includes similar elements. The lightguide assembly 300 of FIG. 3 includes three lightguide plates 306-1, 306-2, and 306-3, each one for image light 308 of one of red (R), green (G), and blue (B) color channels. Each lightguide plate 306-1, 306-2, and 306-3 includes an in-coupler 308 and an out-coupler 310. At least one of the in-couplers 308, and preferably two upstream in-couplers 308, includes a switchable grating for switchably in-coupling the image light into the corresponding lightguide plate 306.

Furthermore, at least one of the out-couplers 310 may also include a switchable grating for switchably out-coupling the image light from the corresponding lightguide plate 306. This may improve the overall transparency of the lightguide assembly 300 to external light 314 on a common path 316 with the image light 302, and reduce undesired rainbow effects. The same consideration applies to the lightguide assembly 100 of FIG. 1 and the external light 114 on the common light path 116. Types and variants of switchable gratings will be considered in detail further below. The lightguide plates 306-1, 306-2, and 306-3 are separated optically, preventing evanescent leakage or refractive coupling of the image light between individual lightguide plates 306-1, 306-2, and 306-3. For example, the lightguide plates 306-1, 306-2, and 306-3 may be separated by a set of spacers 307, e.g. glass honeycomb structures and/or a low refractive index material, having a thickness of at least three micrometers.

Referring now to FIG. 4 with further reference to FIG. 1, a display device 450 is an embodiment of the NED 150 of FIG. 1, and includes similar elements as the NED 150. The display device 450 of FIG. 4 includes an image projector 403 for providing image light 402 carrying an image in angular domain to be displayed to a user of the display device 450. The display device 450 further includes a lightguide assembly 400 including a stack of optically separated lightguide plates, such as the lightguide assembly 100 of FIG. 1, the lightguide assembly 200 of FIG. 2, and/or the lightguide assembly 300 of FIG. 3.

A controller 460 is operably coupled to the projector 403 and the lightguide assembly 400. The controller 460 may be configured to cause the projector 403 to provide a first portion of the image light carrying a first portion of the image in angular domain conveyed by a first lightguide plate of the stack, and provide a second portion of the image light carrying a second portion of the image in angular domain conveyed by a second lightguide plate of the stack. The first and second portions of the image in angular domain may include e.g. first and second portions of field of view (FOV), respectively, of the image in angular domain, and/or first and second color channels, respectively, of the image in angular domain.

In some embodiments, the display device 450 further includes a disparity sensor 462 for sensing an offset between the first and second portions of the image in angular domain at the eyebox. The controller 460 may be further configured to cause the projector 403 to offset the first and second portions of the image in angular domain to lessen an offset between the first and second portions of the image in angular domain at the eyebox due to misalignment of the first and second lightguide plates.

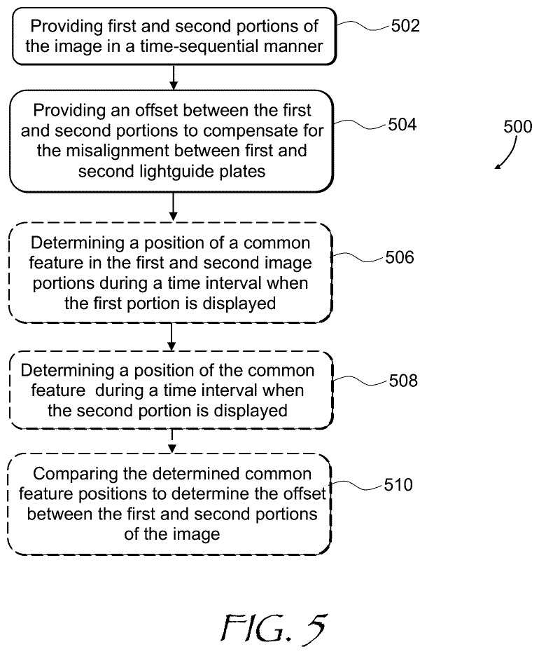

A corresponding method 500 for lessening the offset between image portions is presented in FIG. 5. The method 500 includes providing (502) the first and second portions of the image in angular domain in a time-sequential manner, and providing (504) an offset between the first and second portions of the image in angular domain to compensate for, or lessen, the misalignment between first and second lightguide plates.

To determine the offset, the method 500 may rely on some common feature of the first and second portions of the image, which may be either naturally occurring feature or a generated common feature. The first portion of the image may be provided during a first time interval, and the second portion of the image may be provided during a second, subsequent time interval. The method 500 may further include determining (506) a position of the common feature during the first time interval, determining (508) a position of the common feature during the second time interval, and comparing (510) the determined common feature positions to determine the offset between the first and second portions of the image required to compensate between the misalignment between the first and second lightguide plates.

The first and second portions of the image in angular domain may be e.g. first and second portions of field of view (FOV), respectively, of the image in angular domain/The FOV portions may overlap to avoid a discontinuity in the displayed image, and the common feature may be disposed in the overlap area. In embodiments where the first and second portions of the image in angular domain include first and second color channels, respectively, of the image in angular domain, the common feature may be any feature of the generated image that is represented in both the first and second color channels, e.g. a white feature on a black background.

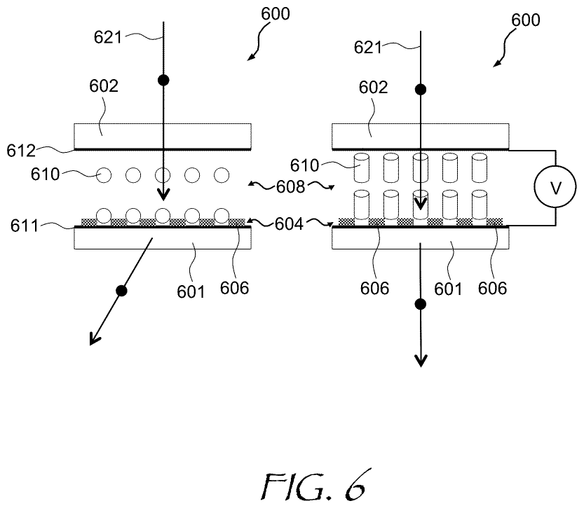

Non-limiting examples of switchable/tunable gratings usable in lightguides and displays of this disclosure will now be presented. Referring first to FIG. 6, a tunable liquid crystal (LC) surface-relief grating 600 may be used e.g. in the in-coupler 108 and/or the out-coupler 110 of FIG. 1 or in the in-coupler 308 and/or the out-coupler 310 of FIG. 3. The tunable LC surface-relief grating 600 includes a first substrate 601 supporting a first conductive layer 611 and a surface-relief grating structure 604 having a plurality of ridges 606 extending from the first substrate 601 and/or the first conductive layer 611.

A second substrate 602 is spaced apart from the first substrate 601. The second substrate 602 supports a second conductive layer 612. A cell is formed by the first 611 and second 612 conductive layers. The cell is filled with a LC fluid, forming an LC layer 608. The LC layer 608 includes nematic LC molecules 610, which may be oriented by an electric field across the LC layer 608. The electric field may be provided by applying a voltage V to the first 611 and second 612 conductive layers.

The surface-relief grating structure 604 may be formed from a polymer with an isotropic refractive index nₚ of about 1.5, for example. The LC fluid has an anisotropic refractive index. For light polarization parallel to a director of the LC fluid, i.e. to the direction of orientation of the nematic LC molecules 610, the LC fluid has an extraordinary refractive index nₑ, which may be higher than an ordinary refractive index nₒ of the LC fluid for light polarization perpendicular to the director. For example, the extraordinary refractive index nₑ may be about 1.7, and the ordinary refractive index nₒ may be about 1.5, i.e. matched to the refractive index nₚ of the surface-relief grating structure 604.

When the voltage V is not applied (left side of FIG. 6), the LC molecules 610 are aligned approximately parallel to the grooves of the surface-relief grating structure 604. At this configuration, a linearly polarized light beam 621 with e-vector oriented along the grooves of the surface-relief grating structure 604 will undergo diffraction, since the surface-relief grating structure 604 will have a non-zero refractive index contrast. When the voltage V is applied (right side of FIG. 6), the LC molecules 610 are aligned approximately perpendicular to the grooves of the surface-relief grating structure 604. At this configuration, a linearly polarized light beam 621 with e-vector oriented along the grooves of the surface-relief grating structure 604 will not undergo diffraction because the surface-relief grating structure 604 will appear to be index-matched and, accordingly, will have a substantially zero refractive index contrast. For the linearly polarized light beam 621 with e-vector oriented perpendicular to the grooves of the surface-relief grating structure 604, no diffraction will occur in either case (i.e. when the voltage is applied and when it is not) because at this polarization of the linearly polarized light beam 621, the surface-relief grating structure 604 are index-matched. Thus, the tunable LC surface-relief grating 600 can be switched on and off (for polarized light) by controlling the voltage across the LC layer 608. Several such gratings with differing pitch/slant angle/refractive index contrast may be used to switch between several grating configurations.

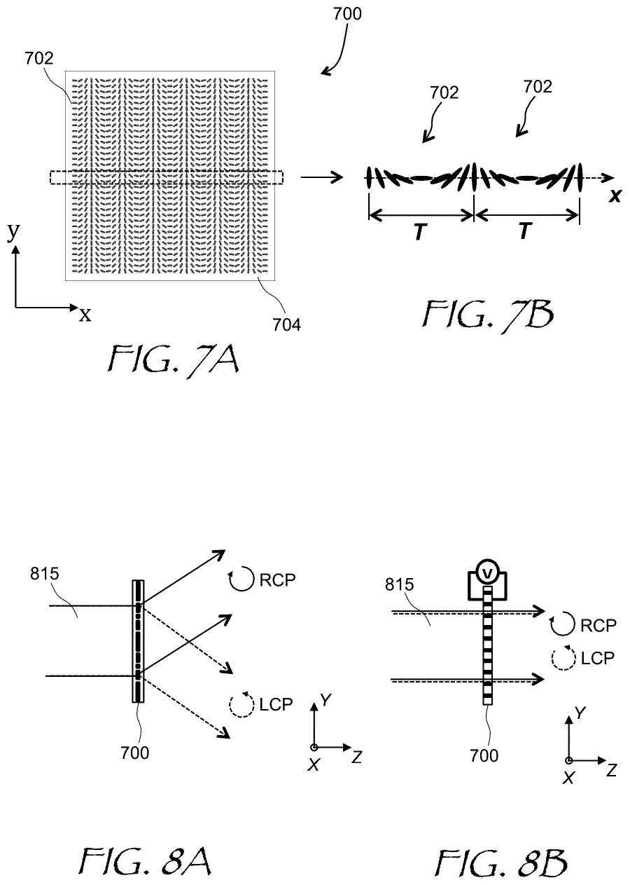

Referring now to FIG. 7A, a Pancharatnam-Berry phase (PBP) LC switchable grating 700 may be used e.g. in the in-coupler 108 and/or the out-coupler 110 of FIG. 1, or in the in-coupler 308 and/or the out-coupler 310 of FIG. 3. The PBP LC switchable grating 700 of FIG. 7A includes LC molecules 702 in an LC layer 704. The LC molecules 702 are disposed in XY plane at a varying in-plane orientation depending on the X coordinate. The orientation angle ϕ(x) of the LC molecules 702 in the PBP LC switchable grating 700 is given by

ϕ(x)=πx/T=πx sin θ/λₒ (1)

where λₒ is the wavelength of impinging light, T is a pitch of the PBP LC switchable grating 700, and θ is a diffraction angle given by

θ=sin⁻¹(λₒ/T) (2)

The azimuthal angle ϕ varies continuously across the surface of the LC layer 704 parallel to XY plane as illustrated in FIG. 7B. The variation has a constant period equal to T. The optical phase delay P in the PBP LC grating 700 of FIG. 7A is due to the PBP effect, which manifests P(x)=2ϕ(x) when the optical retardation R of the LC layer 704 is equal to λₒ/2.

The LC layer 704 may be disposed between parallel substrates configured for applying an electric field across the LC layer 704. The LC molecules 702 are oriented substantially parallel to the substrates in absence of the electric field, and substantially perpendicular to the substrates in presence of the electric field, making the PBP structure “erasable”.

FIGS. 8A and 8B illustrate the operation of the PBP LC switchable grating 700 of FIG. 7A. In FIG. 8A, the PBP LC switchable grating 700 is in OFF state, such that its LC molecules 702 (FIGS. 7A, 7B) are disposed predominantly parallel to the substrate plane, that is, parallel to XY plane in FIG. 7A. When an incoming light beam 815 is left-circular polarized (LCP), the PBP LC switchable grating 700 redirects the light beam 815 upwards by a pre-determined non-zero angle, and the beam 815 becomes right-circular polarized (RCP). The RCP deflected beam 815 is shown with solid lines. When the incoming light beam 815 is right-circular polarized (RCP), the PBP LC switchable grating 700 redirects the beam 815 downwards by a pre-determined non-zero angle, and the beam 815 becomes left-circular polarized (LCP). The LCP deflected beam 815 is shown with dashed lines. Applying a voltage V to the PBP LC switchable grating 700 reorients the LC molecules along Z-axis, i.e. perpendicular to the substrate plane as shown in FIG. 7B. At this orientation of the LC molecules 702, the PBP structure is erased, and the light beam 815 retains its original direction, whether it is LCP or RCP. Thus, the active PBP LC grating 700 is a tunable grating, i.e. it has a variable beam steering property. Furthermore, the operation of the active PBP LC grating 700 may be controlled by controlling the polarization state of the impinging light beam 815.

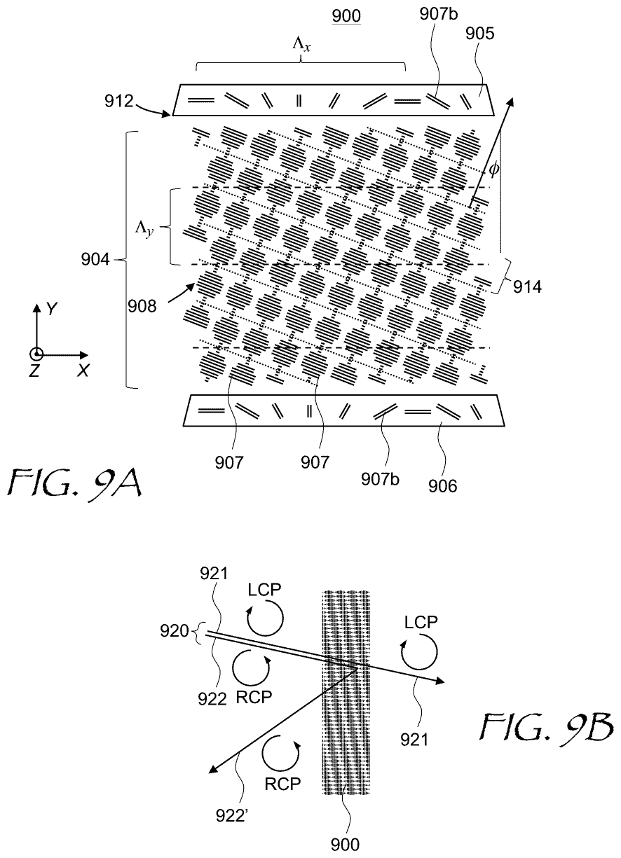

Turning to FIG. 9A, a polarization volume hologram (PVH) grating 900 may be used e.g. in the in-coupler 208 and/or the out-coupler 210 of FIG. 2. The PVH grating 900 of FIG. 9A includes an LC layer 904 bound by opposed top 905 and bottom 906 parallel surfaces. The LC layer 904 may include an LC fluid containing rod-like LC molecules 907 with positive dielectric anisotropy, i.e. nematic LC molecules. A chiral dopant may be added to the LC fluid, causing the LC molecules in the LC fluid to self-organize into a periodic helical configuration including helical structures 908 extending between the top 905 and bottom 906 parallel surfaces of the LC layer 904. Such a configuration of the LC molecules 907, termed herein a cholesteric configuration, includes a plurality of helical periods p, e.g. at least two, at least five, at least ten, at least twenty, or at least fifty helical periods p between the top 905 and bottom 906 parallel surfaces of the LC layer 904.

Boundary LC molecules 907b at the top surface 905 of the LC layer 904 may be oriented at an angle to the top surface 905. The boundary LC molecules 907b may have a spatially varying azimuthal angle, e.g. linearly varying along X-axis parallel to the top surface 905, as shown in FIG. 9A. To that end, an alignment layer 912 may be provided at the top surface 905 of the LC layer 904. The alignment layer 912 may be configured to provide the desired orientation pattern of the boundary LC molecules 907b, such as the linear dependence of the azimuthal angle on the X-coordinate. A pattern of spatially varying polarization directions of the UV light may be selected to match a desired orientation pattern of the boundary LC molecules 907b at the top surface 905 and/or the bottom surface 906 of the LC layer 904. When the alignment layer 912 is coated with the cholesteric LC fluid, the boundary LC molecules 907b are oriented along the photopolymerized chains of the alignment layer 912, thus adopting the desired surface orientation pattern. Adjacent LC molecules adopt helical patterns extending from the top 905 to the bottom 906 surfaces of the LC layer 904, as shown.

The boundary LC molecules 907b define relative phases of the helical structures 908 having the helical period p. The helical structures 908 form a volume grating comprising helical fringes 914 tilted at an angle ϕ, as shown in FIG. 9A. The steepness of the tilt angle ϕ depends on the rate of variation of the azimuthal angle of the boundary LC molecules 907b at the top surface 905 and p. Thus, the tilt angle ϕ is determined by the surface alignment pattern of the boundary LC molecules 907b at the alignment layer 912. The volume grating has a period Λₓ along X-axis and Λ_{y} along Y-axis. In some embodiments, the periodic helical structures 908 of the LC molecules 907 may be polymer-stabilized by mixing in a stabilizing polymer into the LC fluid, and curing (polymerizing) the stabilizing polymer.

The helical nature of the fringes 914 of the volume grating makes the PVH grating 900 preferably responsive to light of polarization having one particular handedness, e.g. left- or right-circular polarization, while being substantially non-responsive to light of the opposite handedness of polarization. Thus, the helical fringes 914 make the PVH grating 900 polarization-selective, causing the PVH grating 900 to diffract light of only one handedness of circular polarization. This is illustrated in FIG. 9B, which shows a light beam 920 impinging onto the PVH grating 900. The light beam 920 includes a left circular polarized (LCP) beam component 921 and a right circular polarized (RCP) beam component 922. The LCP beam component 921 propagates through the PVH grating 900 substantially without diffraction. Herein, the term “substantially without diffraction” means that, even though an insignificant portion of the beam (the LCP beam component 921 in this case) might diffract, the portion of the diffracted light energy is so small that it does not impact the intended performance of the PVH grating 900. The RCP beam component 922 of the light beam 920 undergoes diffraction, producing a diffracted beam 922′. The polarization selectivity of the PVH grating 900 results from the effective refractive index of the grating being dependent on the relationship between the handedness, or chirality, of the impinging light beam and the handedness, or chirality, of the grating fringes 914. Changing the handedness of the impinging light may be used to switch the performance of the PVH grating 900. The PVH grating 900 may also be made tunable by applying voltage to the LC layer 904, which distorts or erases the above-described helical structure. It is further noted that sensitivity of the PVH 900 to right circular polarized light in particular is only meant as an illustrative example. When the handedness of the helical fringes 914 is reversed, the PVH 900 may be made sensitive to left circular polarized light. Thus, the operation of the PVH 900 may be controlled by controlling the polarization state of the impinging light beam 920. Furthermore, in some embodiments the PVH 900 may be made tunable by application of electric field across the LC layer 904, which erases the periodic helical structures 908.

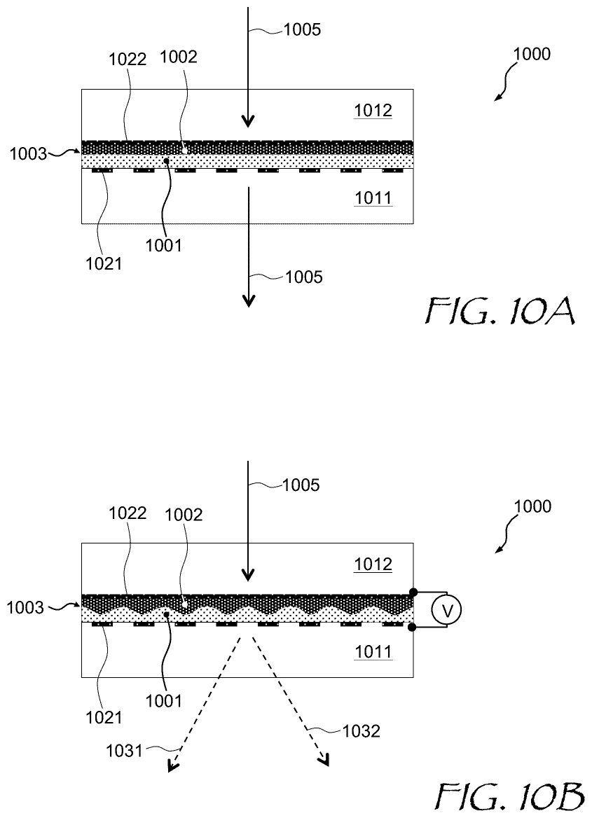

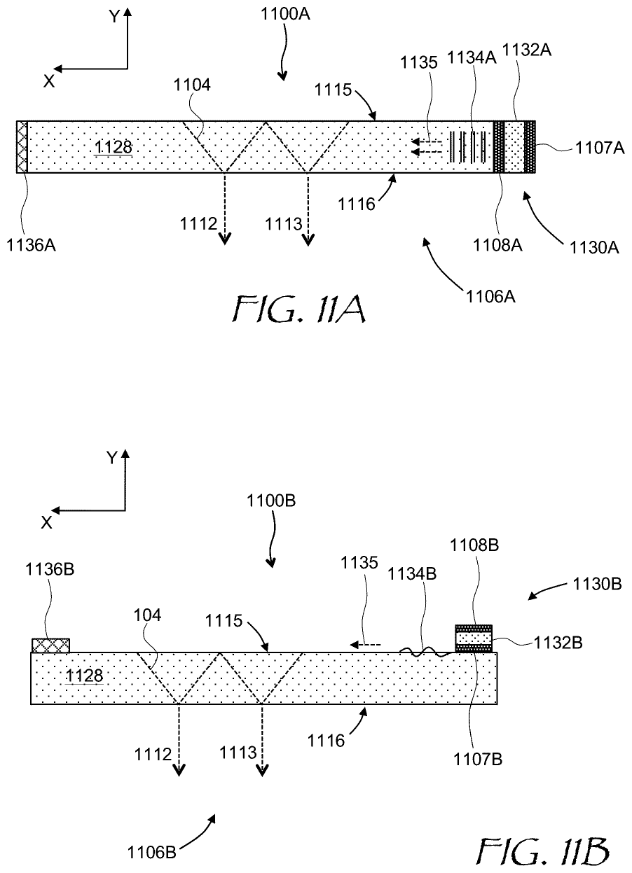

Referring now to FIGS. 10A and 10B, a fluidic surface-relief grating 1000 may be used e.g. in the in-coupler 108 and/or the out-coupler 110 of FIG. 1 or in the in-coupler 308 and/or the out-coupler 310 of FIG. 3. The fluidic surface-relief grating 1000 of FIGS. 10A and 10B includes first 1001 and second 1002 immiscible fluids separated by an inter-fluid boundary 1003. One of the fluids may be a hydrophobic fluid such as oil, e.g. silicone oil, while the other fluid may be water-based. One of the first 1001 and second 1002 fluids may be a gas in some embodiments. The first 1001 and second 1002 fluids may be contained in a cell formed by first 1011 and second 1012 substrates supporting first 1021 and second 1022 electrode structures. The first 1021 and/or second 1022 electrode structures may be at least partially transparent, absorptive, and/or reflective.

At least one of the first 1021 and second 1022 electrode structures may be patterned for imposing a spatially variant electric field onto the 1001 and second 1002 fluids. For example, in 10A and 10B, the first electrode 1021 is patterned, and the second electrodes 1022 is not patterned, i.e. the second electrodes 1022 is a backplane electrode. In the embodiment shown, both the first 1021 and second 1022 electrodes are substantially transparent. For example, the first 1021 and second 1022 electrodes may be indium tin oxide (ITO) electrodes. The individual portions of a patterned electrode may be individually addressable. In some embodiments, the patterned electrode 1021 may be replaced with a continuous, non-patterned electrode coupled to a patterned dielectric layer for creating a spatially non-uniform electric field across the first 1001 and second 1002 fluids.

FIG. 10A shows the fluidic surface-relief grating 1000 in a non-driven state when no electric field is applied across the inter-fluid boundary 1003. When no electric field is present, the inter-fluid boundary 1003 is straight and smooth; accordingly, a light beam 1005 impinging onto the fluidic surface-relief grating 1000 does not diffract, propagating right through as illustrated. FIG. 10B shows the fluidic surface-relief grating 1000 in a driven state when a voltage V is applied between the first 1021 and second 1022 electrodes, producing a spatially variant electric field across the first 1001 and second 1002 fluids separated by the inter-fluid boundary 1003. The application of the spatially variant electric field causes the inter-fluid boundary 1003 to distort as illustrated in FIG. 9B, forming a periodic variation of effective refractive index, i.e. a surface-relief diffraction grating. The light beam 1005 impinging onto the fluidic surface-relief grating 1000 will diffract, forming first 1031 and second 1032 diffracted sub-beams. By varying the amplitude of the applied voltage V, the strength of the fluidic surface-relief grating 1000 may be varied. By applying different patterns of the electric field e.g. with individually addressable sub-electrodes or pixels of the first electrode 1021, the grating period and, accordingly, the diffraction angle, may be varied. More generally, varying the effective voltage between separate sub-electrodes or pixels of the first electrode 1021 may result in a three-dimensional conformal change of the fluidic interface i.e. the inter-fluid boundary 1003 inside the fluidic volume to impart a desired optical response to the fluidic surface-relief grating 1000. The applied voltage pattern may be pre-biased to compensate or offset gravity effects, i.e. gravity-caused distortions of the inter-fluid boundary 1003.

The thickness of the first 1021 and second 1022 electrodes may be e.g. between 10 nm and 50 nm. The materials of the first 1021 and second 1022 electrodes besides ITO may be e.g. indium zinc oxide (IZO), zinc oxide (ZO), indium oxide (TO), tin oxide (TO), indium gallium zinc oxide (IGZO), etc. The first 1001 and second 1002 fluids may have a refractive index difference of at least 0.1, and may be as high as 0.2 and higher. One of the first 1001 or second 1002 fluids may include polyphenylether, 1,3-bis(phenylthio)benzene, etc. The first 1011 and/or second 1012 substrates may include e.g. fused silica, quartz, sapphire, etc. The first 1011 and/or second 1012 substrates may be straight or curved, and may include vias and other electrical interconnects. The applied voltage may be varied in amplitude and/or duty cycle when applied at a frequency of between 100 Hz and 100 kHz. The applied voltage can change polarity and/or be bipolar. Individual first 1001 and/r second 1002 fluid layers may have a thickness of between 0.5-5 micrometers, more preferably between 0.5-2 micrometer.

To separate the first 1001 and second 1002 fluids, surfactants containing one hydrophilic end functional group and one hydrophobic end functional group may be used. The examples of a hydrophilic end functional group are hydroxyl, carboxyl, carbonyl, amino, phosphate, sulfhydryl. The hydrophilic functional groups may also be anionic groups such as sulfate, sulfonate, carboxylates, phosphates, for example. Non-limiting examples of a hydrophobic end functional group are aliphatic groups, aromatic groups, fluorinated groups. For example, when polyphenyl thioether and fluorinated fluid may be selected as a fluid pair, a surfactant containing aromatic end group and fluronirated end group may be used. When phenyl silicone oil and water are selected as the fluid pair, a surfactant containing aromatic end group and hydroxyl (or amino, or ionic) end group may be used. These are only non-limiting examples.

Referring to FIG. 11A, a pupil-replicating lightguide 1100A illustrates that an acoustic grating may be used as a switchable in- and/or out-coupler of a lightguide plate of this disclosure. The pupil-replicating lightguide 1100A includes a body 1106A having two portions, a substrate 1128 for propagating image light 1104, and a volume-wave acoustic actuator 1130A mechanically coupled at a side of the substrate 1128 joining its top 1115 and bottom 1116 surfaces. In the embodiment shown, the volume-wave acoustic actuator 1130A includes an electrically responsive layer 1132A, e.g. a piezoelectric layer, disposed between electrodes 1107A, 1108A. In operation, an electrical signal at a high frequency, typically in the range of 1 MHz to 100 MHz or higher, is applied to the electrodes 1107A, 1108A causing the electrically responsive layer 1132A to oscillate, typically at a frequency of a mechanical resonance of the electrically responsive layer 1132A. The oscillating thickness of the electrically responsive layer 1132A creates a volume acoustic wave 1134A propagating in the substrate 1128 in a direction 1135, i.e. along the X-axis. The volume acoustic wave 1134A modulates the refractive index of the substrate 1128 due to the effect of photoelasticity. The modulated refractive index creates a diffraction grating that out-couples portions 1112, 1113 of the image light 1104 from the pupil-replicating lightguide 1100A. By changing the strength of the electric signal applied to the volume-wave acoustic actuator 1130A, the strength of the out-coupling grating may be changed. The out-coupling grating may be switched ON and OFF by switching ON and OFF the oscillating electric signal. The grating period may be changed by changing the frequency of the oscillating electric signal. In some embodiments, an acoustic wave terminator 1136A can be coupled to an opposite side of the substrate 1128 to absorb the volume acoustic wave 1134A and thus prevent a standing acoustic wave formation in the substrate 1128.

Turning to FIG. 10B, a pupil-replicating waveguide 1100B illustrates that an acoustic grating may be used as a switchable in- and/or out-coupler of a lightguide plate. The pupil-replicating waveguide 1100B includes a waveguide body 1106B having two portions, the substrate 1128 for propagating the beam of image light 1104, and a surface-wave acoustic actuator 1130B mechanically coupled at the top surface 1115. Alternatively, the surface-wave acoustic actuator 1130B may also be coupled at the bottom surface 1116. In the embodiment shown, the surface-wave acoustic actuator 1130B includes an electrically responsive layer 1132B, e.g. a piezoelectric layer, disposed between electrodes 1107B, 1108B. In operation, an electrical signal at a high frequency, typically in the range of 1 MHz to 100 MHz or higher, is applied to the electrodes 1107B, 1108B causing the electrically responsive layer 1132B to oscillate. The oscillation of the electrically responsive layer 1132A creates a surface acoustic wave 1134B propagating in the substrate 1128 in the direction 1135, i.e. along the X-axis. The surface acoustic wave 1134B forms a diffraction grating that out-couples the portions 1112, 1113 of the image light 1104 from the pupil-replicating lightguide 1100B. By changing the strength of the electric signal applied to the surface-wave acoustic actuator 1130B, the strength of the surface grating may be changed. The surface grating may be switched ON and OFF by switching ON and OFF the oscillating electric signal. The grating period may be changed by changing the frequency of the oscillating electric signal. In some embodiments, an acoustic wave terminator 1136B can be coupled to an opposite side of the substrate 1128 at the same surface, i.e. at the top surface 1115 in FIG. 11B, to absorb the surface acoustic wave 1134B and thus prevent a standing acoustic wave formation.

Some switchable gratings include a material with tunable refractive index. By way of a non-limiting example, a holographic polymer-dispersed liquid crystal (H-PDLC) grating may be manufactured by causing interference between two coherent laser beams in a photosensitive monomer/liquid crystal (LC) mixture contained between two substrates coated with a conductive layer. Upon irradiation, a photoinitiator contained within the mixture initiates a free-radical reaction, causing the monomer to polymerize. As the polymer network grows, the mixture phase separates into polymer-rich and liquid-crystal rich regions. The refractive index modulation between the two phases causes light passing through the cell to be scattered in the case of traditional PDLC or diffracted in the case of H-PDLC. When an electric field is applied across the cell, the index modulation is removed and light passing through the cell is unaffected. This is described in an article entitled “Electrically Switchable Bragg Gratings from Liquid Crystal/Polymer Composites” by Pogue et al., Applied Spectroscopy, v. 54 No. 1, 2000, which is incorporated herein by reference in its entirety.

Tunable or switchable gratings with a variable grating period may be produced e.g. by using flexoelectric LC. For LCs with a non-zero flexoelectric coefficient difference (e1-e3) and low dielectric anisotropy, electric fields exceeding certain threshold values result in transitions from the homogeneous planar state to a spatially periodic one. Field-induced grating is characterized by rotation of the LC director about the alignment axis with the wavevector of the grating oriented perpendicular to the initial alignment direction. The rotation sign is defined by both the electric field vector and the sign of the (e1-e3) difference. The wavenumber characterizing the field-induced periodicity is increased linearly with the applied voltage starting from a threshold value of about it/d, where d is the thickness of the layer. A description of flexoelectric LC gratings may be found e.g. in an article entitled “Dynamic and Photonic Properties of Field-Induced Gratings in Flexoelectric LC Layers” by Palto in Crystals 2021, 11, 894, which is incorporated herein by reference in its entirety.

Tunable gratings with a variable grating period or a slant angle may be provided e.g. by using helicoidal LC. Tunable gratings with helicoidal LCs have been described e.g. in an article entitled “Electrooptic Response of Chiral Nematic Liquid Crystals with Oblique Helicoidal Director” by Xiang et al. Phys. Rev. Lett. 112, 217801, 2014, which is incorporated herein by reference in its entirety.

For gratings exhibiting strong wavelength dependence of grating efficiency, several gratings, e.g. several volumetric Bragg grating (VBG) gratings, may be provided in the lightguide. The gratings that diffract light at any given moment of time may be switched by switching the VBG grating on and off, and/or by switching the wavelength of the light propagating in the waveguide.

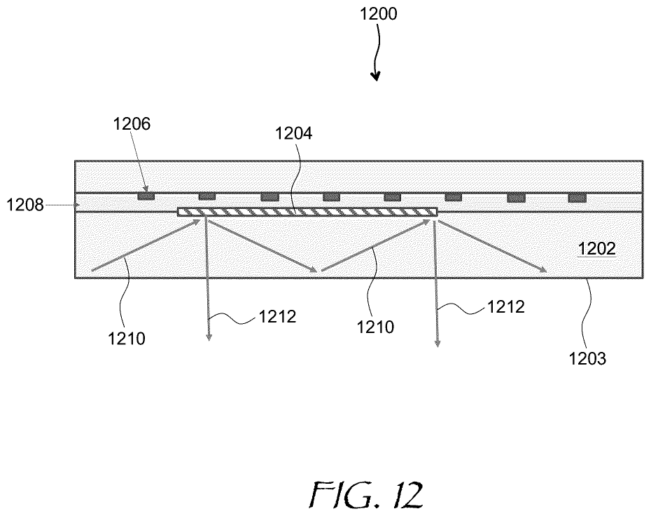

Referring now to FIG. 12, a lightguide 1200 of this disclosure may include any of the lightguides disclosed herein that rely on a pixelated electrode layer to apply a spatially varying electrical signal, e.g. spatially-varying voltage, to a layer of the lightguide such as, for example and without limitation, a voltage-controlled in-coupling and/or out-coupling grating. The lightguide 1200 includes a lightguide body 1202, e.g. a slab of a transparent material such as glass, plastic, metal oxide, crystal etc., a voltage-controlled layer 1204 configured to provide a required optical function e.g. a diffraction grating, a reflector, an actuator etc., disposed in/supported by the lightguide body 1202. An array of electrodes 1206 is disposed within or on the lightguide body 1202 for applying spatially-variant electric field to the voltage-controlled layer 1204. The array of electrodes 1206 is separated from the voltage-controlled layer 1204 by a low-index transparent layer 1208 such as a porous Teflon layer, for example.

In operation, image light 1210 propagates in the lightguide body 1202 by a series of total internal reflections from a surface 1203 of the lightguide body 1202 and the low-index transparent layer 1208, forming a zigzag light path as illustrated. The voltage-controlled layer 1204, which in this case may include an out-coupling diffraction grating with a voltage-controlled grating strength or diffraction efficiency, is disposed in the light path of the image light 1210. The electrodes 1206 may be energized to control the out-coupling efficiency of different portions 1212 of the out-coupling diffraction grating in a spatially-selective manner. The low-index layer 1208 functions as a light barrier, preventing the image light 1210 from reaching the array of electrodes 1206 and undergoing absorption by the array of electrodes 1206, thereby improving light utilization efficiency.

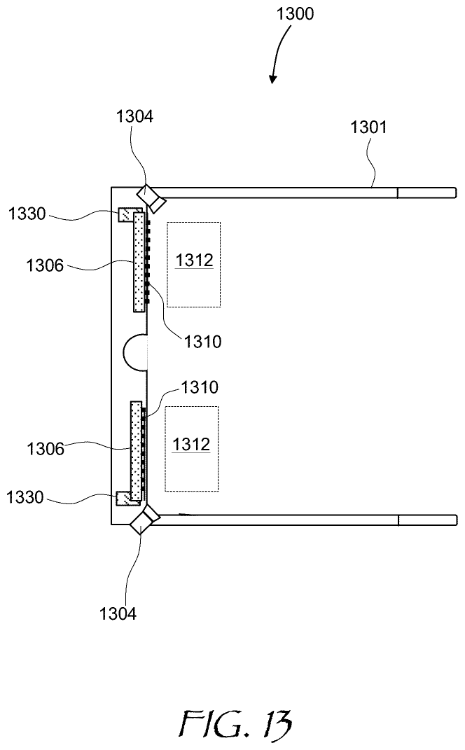

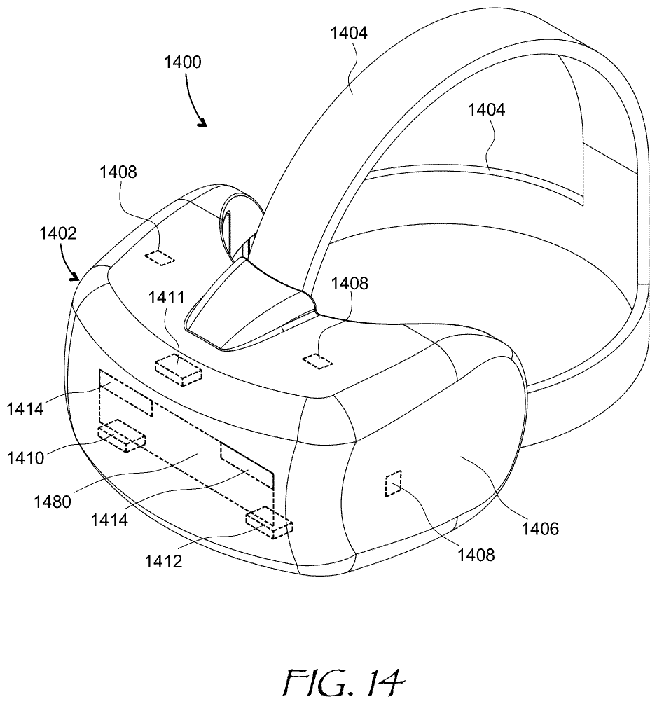

Turning to FIG. 13, an augmented reality (AR) near-eye display 1300 may use any of the lightguide assemblies and displays disclosed herein. The AR near-eye display 1300 includes a frame 1301 supporting, for each eye: a light engine 1330 for providing an image light beam carrying an image in angular domain, a pupil-replicating lightguide 1306 including any of the lightguide assemblies and stacks of lightguide plates disclosed herein, for providing multiple offset portions of the image light beam to spread the image in angular domain across an eyebox 1312, and a plurality of eyebox illuminators 1310, shown as black dots, spread around a clear aperture of the pupil-replicating lightguide 1306 on a surface that faces the eyebox 1312. An eye-tracking camera 1304 may be provided for each eyebox 1312.

The purpose of the eye-tracking cameras 1304 is to determine position and/or orientation of both eyes of the user. The eyebox illuminators 1310 illuminate the eyes at the corresponding eyeboxes 1312, allowing the eye-tracking cameras 1304 to obtain the images of the eyes, as well as to provide reference reflections i.e. glints. The glints may function as reference points in the captured eye image, facilitating the eye gazing direction determination by determining position of the eye pupil images relative to the glints images. To avoid distracting the user with the light of the eyebox illuminators 1310, the latter may be made to emit light invisible to the user. For example, infrared light may be used to illuminate the eyeboxes 1312.

Referring now to FIG. 14, an HMD 1400 is an example of an AR/VR wearable display system which encloses the user's face, for a greater degree of immersion into the AR/VR environment. The HMD 1400 may generate the entirely virtual 3D imagery. The HMD 1400 may include a front body 1402 and a band 1404 that can be secured around the user's head. The front body 1402 is configured for placement in front of eyes of a user in a reliable and comfortable manner. A display system 1480 may be disposed in the front body 1402 for presenting AR/VR imagery to the user. The display system 1480 may include any of the display devices and lightguide assemblies disclosed herein. Sides 1406 of the front body 1402 may be opaque or transparent.

In some embodiments, the front body 1402 includes locators 1408 and an inertial measurement unit (IMU) 1410 for tracking acceleration of the HMD 1400, and position sensors 1412 for tracking position of the HMD 1400. The IMU 1410 is an electronic device that generates data indicating a position of the HMD 1400 based on measurement signals received from one or more of position sensors 1412, which generate one or more measurement signals in response to motion of the HMD 1400. Examples of position sensors 1412 include: one or more accelerometers, one or more gyroscopes, one or more magnetometers, another suitable type of sensor that detects motion, a type of sensor used for error correction of the IMU 1410, or some combination thereof. The position sensors 1412 may be located external to the IMU 1410, internal to the IMU 1410, or some combination thereof.

The locators 1408 are traced by an external imaging device of a virtual reality system, such that the virtual reality system can track the location and orientation of the entire HMD 1400. Information generated by the IMU 1410 and the position sensors 1412 may be compared with the position and orientation obtained by tracking the locators 1408, for improved tracking accuracy of position and orientation of the HMD 1400. Accurate position and orientation is important for presenting appropriate virtual scenery to the user as the latter moves and turns in 3D space.

The HMD 1400 may further include a depth camera assembly (DCA) 1411, which captures data describing depth information of a local area surrounding some or all of the HMD 1400. The depth information may be compared with the information from the IMU 1410, for better accuracy of determination of position and orientation of the HMD 1400 in 3D space.

The HMD 1400 may further include an eye tracking system 1414 for determining orientation and position of user's eyes in real time. The obtained position and orientation of the eyes also allows the HMD 1400 to determine the gaze direction of the user and to adjust the image generated by the display system 1480 accordingly. The determined gaze direction and vergence angle may be used to adjust the display system 1480 to reduce the vergence-accommodation conflict. The direction and vergence may also be used for displays' exit pupil steering as disclosed herein. Furthermore, the determined vergence and gaze angles may be used for interaction with the user, highlighting objects, bringing objects to the foreground, creating additional objects or pointers, etc. An audio system may also be provided including e.g. a set of small speakers built into the front body 1402.

Embodiments of the present disclosure may include, or be implemented in conjunction with, an artificial reality system. An artificial reality system adjusts sensory information about outside world obtained through the senses such as visual information, audio, touch (somatosensation) information, acceleration, balance, etc., in some manner before presentation to a user. By way of non-limiting examples, artificial reality may include virtual reality (VR), augmented reality (AR), mixed reality (MR), hybrid reality, or some combination and/or derivatives thereof. Artificial reality content may include entirely generated content or generated content combined with captured (e.g., real-world) content. The artificial reality content may include video, audio, somatic or haptic feedback, or some combination thereof. Any of this content may be presented in a single channel or in multiple channels, such as in a stereo video that produces a three-dimensional effect to the viewer. Furthermore, in some embodiments, artificial reality may also be associated with applications, products, accessories, services, or some combination thereof, that are used to, for example, create content in artificial reality and/or are otherwise used in (e.g., perform activities in) artificial reality. The artificial reality system that provides the artificial reality content may be implemented on various platforms, including a wearable display such as an HMD connected to a host computer system, a standalone HMD, a near-eye display having a form factor of eyeglasses, a mobile device or computing system, or any other hardware platform capable of providing artificial reality content to one or more viewers.

The present disclosure is not to be limited in scope by the specific embodiments described herein. Indeed, other various embodiments and modifications, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A lightguide assembly for propagating image light to an eyebox, the lightguide assembly comprising a stack of optically separated lightguide plates for conveying the image light, at least one lightguide plate of the stack comprising:
an in-coupler configured for switchably in-coupling the image light into the lightguide plate; and
an out-coupler for out-coupling spaced apart portions of the image light from the lightguide plate towards the eyebox.

2. The lightguide assembly of claim 1, wherein the stack comprises first and second lightguide plates each comprising an in-coupler configured for switchably in-coupling the image light into the lightguide plate, and an out-coupler for out-coupling spaced apart portions of the image light from the lightguide plate towards the eyebox, wherein:
the in-coupler of the first lightguide plate comprises a first polarization-selective grating for in-coupling light in a first polarization state while propagating therethrough light in a second, orthogonal polarization state; and
the in-coupler of the second lightguide plate comprises a second polarization-selective grating for in-coupling light in the second polarization state while propagating therethrough light in the first polarization state;
the lightguide assembly further comprising a polarization switch upstream of the first and second polarization-selective gratings for switching a polarization state of the image light between the first and second polarization states.

3. The lightguide assembly of claim 1, wherein the in-coupler comprises a switchable grating for switchably in-coupling the image light into a corresponding lightguide plate of the stack.

4. The lightguide assembly of claim 3, wherein the switchable grating comprises a tunable liquid crystal surface-relief grating.

5. The lightguide assembly of claim 3, wherein the switchable grating comprises a Pancharatnam-Berry phase LC switchable grating.

6. The lightguide assembly of claim 3, wherein the switchable grating comprises a polarization volume hologram grating.

7. The lightguide assembly of claim 3, wherein the switchable grating comprises a fluidic grating.

8. The lightguide assembly of claim 3, wherein the switchable grating comprises an acoustic grating.

9. A display device comprising:
a projector for providing image light carrying an image in angular domain;
a lightguide assembly optically coupled to the projector for receiving and propagating the image light to an eyebox, the lightguide assembly comprising a stack of optically separated lightguide plates for conveying the image light therein, at least one lightguide plate of the stack comprising:
an in-coupler configured for switchably in-coupling the image light into the lightguide plate; and
an out-coupler for out-coupling the image light from the lightguide plate towards the eyebox; and
a controller operably coupled to the projector and the lightguide assembly.

10. The display device of claim 9, wherein the in-coupler comprises a switchable grating for switchably in-coupling, responsive to a control signal from the controller, the image light into a corresponding lightguide plate of the stack.

11. The display device of claim 9, wherein the stack comprises first and second lightguide plates, wherein the controller is configured to:
during a first time interval, cause the projector to provide a first portion of the image light carrying a first portion of the image in angular domain, and causing the lightguide assembly to in-couple the image light into the first lightguide plate and to convey the image light in the first lightguide plate towards the eyebox; and
during a second, subsequent time interval, cause the projector to provide a second portion of the image light carrying a second portion of the image in angular domain, and causing the lightguide assembly to in-couple the image light into the second lightguide plate and to convey the image light in the second lightguide plate towards the eyebox.

12. The display device of claim 11, wherein the first and second portions of the image in angular domain comprise first and second portions of field of view (FOV), respectively, of the image in angular domain.

13. The display device of claim 11, wherein the first and second portions of the image in angular domain comprise first and second color channels, respectively, of the image in angular domain.

14. The display device of claim 11, wherein:
the first lightguide plate comprises a first polarization-selective grating for in-coupling light in a first polarization state while propagating therethrough light in a second, orthogonal polarization state; and
the second lightguide plate comprises a second grating for in-coupling light in the second polarization state;
the lightguide assembly further comprising a polarization switch upstream of the first and second lightguide plates for switching, responsive to a control signal from the controller, a polarization state of the image light between the first and second polarization states.

15. The display device of claim 11, further comprising a disparity sensor operably coupled to the controller, for sensing an offset between the first and second portions of the image in angular domain at the eyebox.

16. The display device of claim 15, wherein the controller is configured to cause the projector to offset the first and second portions of the image in angular domain to lessen an offset between the first and second portions of the image in angular domain at the eyebox due to misalignment between the first and second lightguide plates.

17. A method for lessening an offset between first and second portions of an image in angular domain due to misalignment between first and second lightguide plates carrying the first and second portions of the image in angular domain respectively, the method comprising:
providing the first and second portions of the image in angular domain in a time-sequential manner; and
providing an offset between the first and second portions of the image in angular domain to compensate for the misalignment between first and second lightguide plates.

18. The method of claim 17, wherein the first portion of the image is provided during a first time interval and the second portion of the image is provided during a second, subsequent time interval, the first and second portions of the image comprising a common feature, the method further comprising:
determining a position of the common feature during the first time interval;
determining a position of the common feature during the second time interval; and
comparing the determined common feature positions to determine the offset.

19. The method of claim 17, wherein the first and second portions of the image in angular domain comprise first and second portions of field of view (FOV), respectively, of the image in angular domain.

20. The method of claim 17, wherein the first and second portions of the image in angular domain comprise first and second color channels, respectively, of the image in angular domain.
